(19) United States
(12) Patent Application Publication
(10) Pub. No.: US 2025/0314227 A1
(43) Pub. Date: Oct. 9, 2025

(54) VARIABLE POSITION FUEL INJECTOR

(71) Applicant: Polaris Industries Inc., Medina, MN (US)

(72) Inventor: Sean Trihey, Roseau, MN (US)

(21) Appl. No.: 19/170,157

(22) Filed: Apr. 4, 2025

Related U.S. Application Data
(60) Provisional application No. 63/575,023, filed on Apr. 5, 2024.

(51) Int. Cl. F02M 61/14; F02D 41/38

(52) U.S. Cl. CPC F02M 61/14; F02D 41/38; F02M 2200/851

(57) ABSTRACT

A vehicle including a plurality of ground engaging members, a frame supported by the plurality of ground engaging members, a powertrain assembly supported by the frame and operably coupled to at least one of the ground engaging members, wherein the powertrain assembly includes an engine block defining a cylinder and a fuel injector positioned to provide fuel into the cylinder, wherein the fuel injector is moveable between a first position and a second position.

### CROSS-REFERENCE TO RELATED APPLICATIONS

This application claims the benefit of U.S. Provisional Application No. 63/575,023, filed Apr. 5, 2024, and titled “VARIABLE POSITION FUEL INJECTOR” the disclosure of which is hereby incorporated herein by reference.

### TECHNICAL FIELD

The present disclosure relates generally to apparatuses, systems, and methods for injecting fuel into an engine. More specifically, the disclosure relates to apparatuses, systems, and methods for selectively positioning a fuel injector for various injection profiles.

### BACKGROUND

Combustion engines require starting cycles in order to begin the combustion process. Sometimes, before the combustion process begins, the engine may cycle or turn-over several times before the combustion is able to sustain the engine cycle. The starting process may be affected by many variables including the type of engine (e.g., 2-stroke vs. 4-stroke engines), injector dynamics (e.g., fuel atomization, position, and orientation), temperature of the engine and/or fuel, and so forth. Delayed starting can result in engine flooding, battery drain, incomplete combustion, and so forth.

### SUMMARY

According to one example (“Example 1”), a vehicle includes a plurality of ground engaging members; a frame supported by the plurality of ground engaging members; a powertrain assembly supported by the frame and operably coupled to at least one of the ground engaging members, wherein the powertrain assembly includes an engine block defining a cylinder and a fuel injector positioned to provide fuel into the cylinder, wherein the fuel injector is moveable between a first position and a second position.

According to another example (“Example 2”), further to Example 1, the cylinder defines a chamber including a first portion and a second portion, wherein the fuel injector is operable to provide fuel to the first portion of the chamber when in the first position and is operable to provide fuel to the second portion of the chamber when in the second position.

According to another example (“Example 3”), further to Example 1, the fuel injector is angularly adjustable relative to the engine block.

According to another example (“Example 4”), further to Example 3, the fuel injector is angularly adjustable from about 50 degrees to about 90 degrees between the first position and the second position.

According to another example (“Example 5”), further to Example 1, the fuel injector is coupled to the engine block via a pivoting coupling member.

According to another example (“Example 6”), further to Example 5, the pivoting coupling member includes a ball joint.

According to another example (“Example 7”), further to Example 1, the powertrain assembly further includes an actuator coupled to the fuel injector, wherein the actuator is operable to move the fuel injector between the first position and the second position.

According to another example (“Example 8”), further to Example 7, the powertrain assembly further includes a controller, wherein the controller is operable to cause the actuator to transition the fuel injector between the first position and the second position based on a predetermined condition.

According to another example (“Example 9”), further to Example 8, the predetermined condition includes at least one of speed, power status, RPM, ambient temperature, engine temp, and throttle position.

According to another example (“Example 10”), further to Example 1, the powertrain assembly further includes an exhaust valve, wherein the fuel injector is positioned in the first position or the second position based on a position of the exhaust valve.

According to one example (“Example 11”), a powertrain system includes an engine block defining a cylinder; a piston positioned at least partially within the cylinder; and a fuel injector positioned to provide fuel into the cylinder, wherein the fuel injector is moveable between a first position and a second position.

According to another example (“Example 12”), further to Example 11, the cylinder defines a chamber including a first portion and a second portion, wherein the fuel injector is operable to provide fuel to the first portion of the chamber when in the first position and is operable to provide fuel to the second portion of the chamber when in the second position.

According to another example (“Example 13”), further to Example 11, the fuel injector is angularly adjustable relative to the engine block.

According to another example (“Example 14”), further to Example 11, the powertrain system further includes a pivoting coupling member, wherein the fuel injector is coupled to the engine block via the pivoting coupling member.

According to another example (“Example 15”), further to Example 14, the powertrain system further includes an actuator coupled to the fuel injector, wherein the actuator is operable to move the fuel injector between the first position and the second position.

According to another example (“Example 16”), further to Example 15, the powertrain system further includes a controller, wherein the controller is operable to cause the actuator to transition the fuel injector between the first position and the second position based on a predetermined condition.

According to one example (“Example 17”), a fuel injection system for coupling to a powertrain assembly includes a fuel injector positioned to provide fuel into a cylinder of a powertrain assembly; and a coupling member operable to moveably couple the fuel injector to the powertrain assembly, wherein the coupling member is operable to allow the fuel injector to move between a first position and a second position.

According to another example (“Example 18”), further to Example 17, the coupling member includes a ball joint.

According to another example (“Example 19”), further to Example 17, the fuel injection system further includes an actuator coupled to the fuel injector, wherein the actuator is operable to move the fuel injector between the first position and the second position.

According to another example (“Example 20”), further to Example 19, the fuel injection system further includes a controller, wherein the controller is operable to cause the actuator to transition the fuel injector between the first position and the second position based on a predetermined condition.

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is an illustration of a snowmobile, in accordance with an embodiment;

FIG. 2 is an illustration of a powertrain assembly, in accordance with an embodiment;

FIG. 3 is an illustration of cylinders with fuel injectors positioned in various positions, in accordance with an embodiment;

FIG. 4 is a section view of a cylinder with a fuel injector positioned in a first position, in accordance with an embodiment;

FIG. 5 is a section view of the cylinder of FIG. 4 with the fuel injector positioned in a second position, in accordance with an embodiment;

FIG. 6 is a section view of a cylinder with a piston positioned at top dead center, in accordance with an embodiment;

FIG. 7 is a first perspective, section view of a cylinder with a variable position fuel injector, in accordance with an embodiment;

FIG. 8 is a second perspective, section views of a cylinder with a variable position fuel injector, in accordance with an embodiment;

FIG. 9 shows a first view of a variable position fuel injector assembly, in accordance with an embodiment;

FIG. 10 shows a second view a variable position fuel injector assembly, in accordance with an embodiment.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

### DESCRIPTION OF VARIOUS EMBODIMENTS

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

Example embodiments will now be described more fully with reference to the accompanying drawings. Although the following description includes several examples of a snowmobile application, it is understood that the features herein may be applied to any appropriate vehicle, such as motorcycles, all-terrain vehicles, utility vehicles, moped, scooters, and so forth. The examples included herein are not intended to be exhaustive or to limit the disclosure to a specific vehicle type. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. For example, although a two-stroke engine is discussed herein, it is understood that embodiments and principles disclosed herein may likewise be implemented on a four-stroke engine. Additionally, the subject matter discussed herein may also be implemented with respect to (e.g., positioned in or proximate to) the throttle body or intake manifold (in addition to or in alternative to the cylinder). The invention includes any alterations and further modifications in the illustrative devices and described methods and further applications of the principles of the invention which would normally occur to one skilled in the art to which the invention relates.

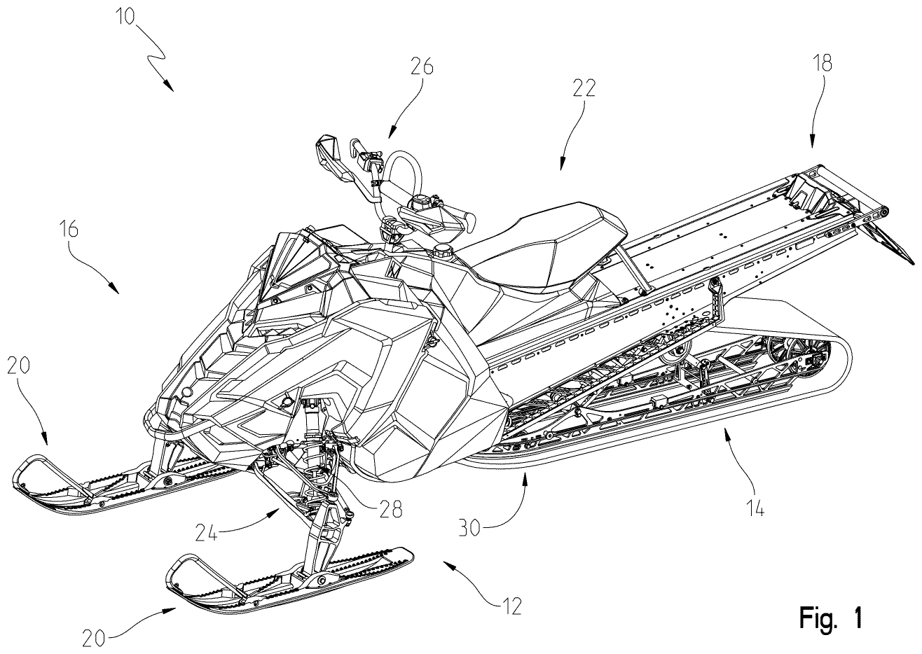

Referring to FIG. 1, in one embodiment a vehicle (e.g., a snowmobile 10) is shown. Snowmobile 10 includes a chassis assembly 12, an endless belt assembly 14, and a pair of front skis 20. Snowmobile 10 also includes a front-end 16 and a rear-end 18. Snowmobile 10 also includes a seat assembly 22 that is coupled to chassis assembly 12. A front suspension assembly 24 is also coupled to chassis assembly 12. The front suspension assembly 24 may include handlebars 26 for steering, shock absorbers 28, and front skis 20. A rear suspension assembly 30 is also coupled to chassis assembly 12. Rear suspension assembly 30 may be used to support endless belt assembly 14 for propelling the vehicle.

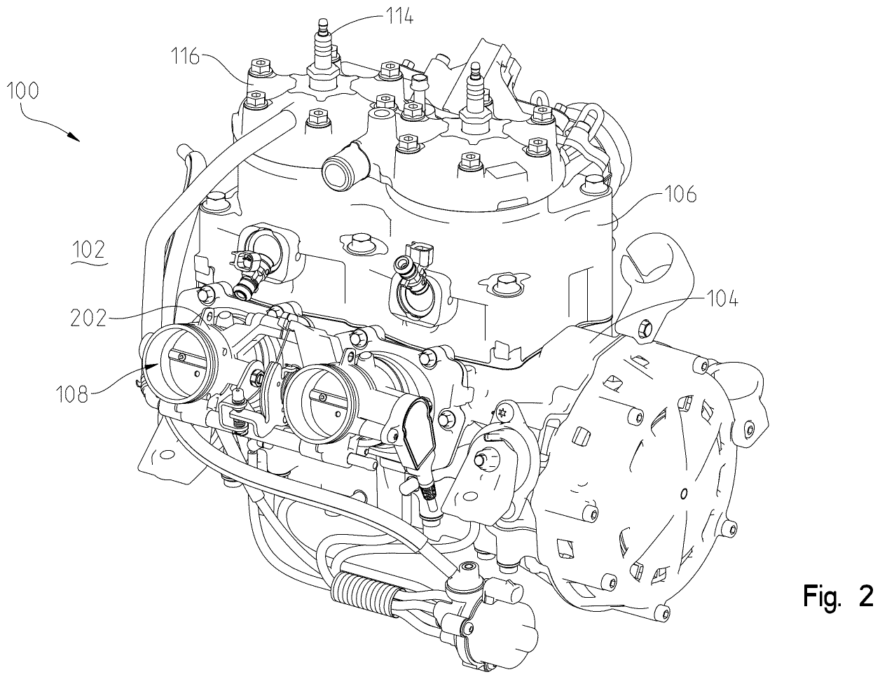

Referring to FIG. 2, snowmobile 10 also includes a powertrain assembly 100. Powertrain assembly 100 is coupled to an intake assembly and an exhaust assembly. Intake assembly is used for providing fuel and air into the powertrain assembly 100 for the combustion process. Exhaust gas leaves the powertrain assembly 100 through the exhaust assembly.

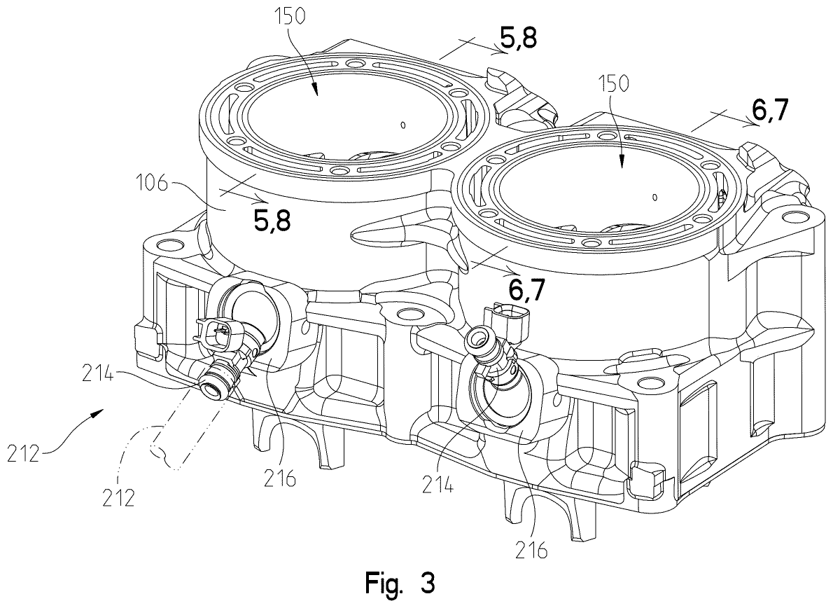

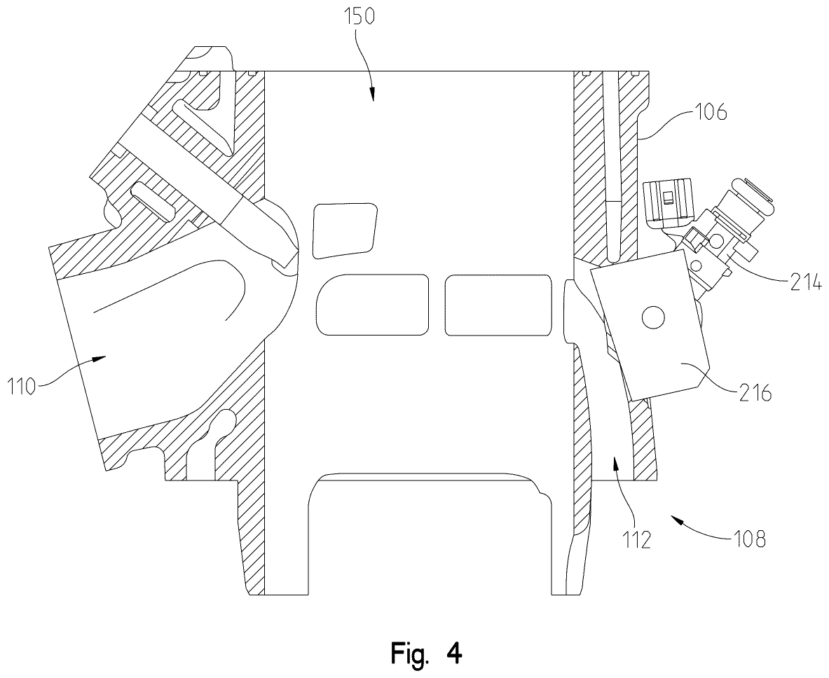

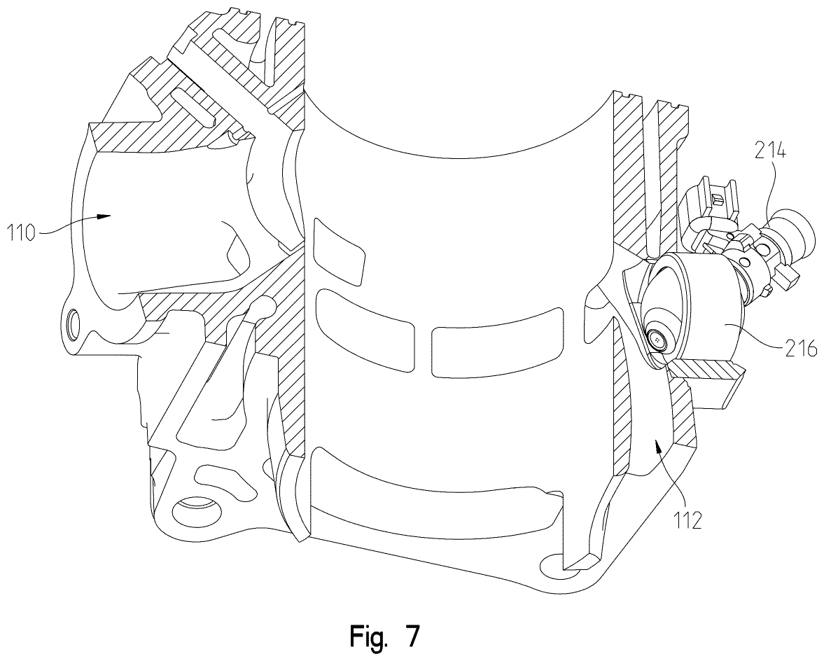

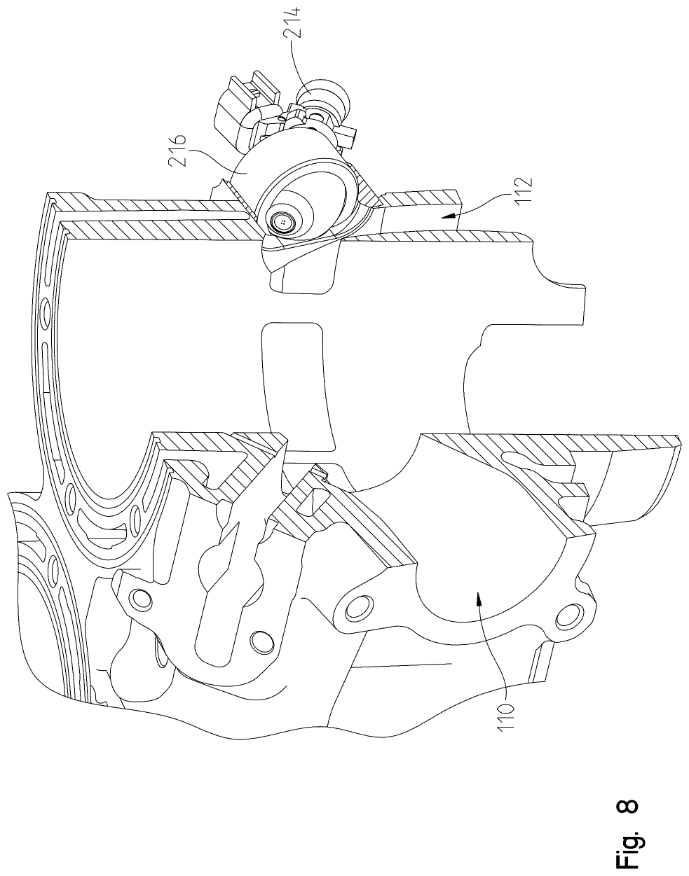

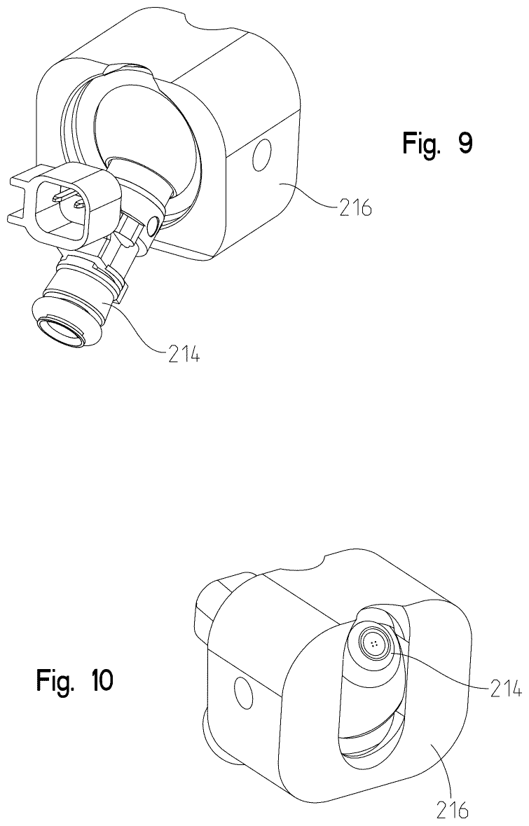

Although snowmobile 10 is discussed herein in more detail, it is understood that any relevant vehicle may incorporate powertrain assembly 100 and the associate components as described herein. Referring more specifically to FIGS. 2-8, powertrain assembly 100 is illustrated in further detail. In some embodiments, powertrain assembly 100 includes an engine 102 (e.g., a two-stroke engine) fluidically coupled to intake assembly that includes intake manifold and intake conduit and fluidically coupled to exhaust assembly that includes an exhaust manifold and an exhaust conduit. Engine 102 includes an engine block 104 defining at least one cylinder 106, the cylinder 106 including a chamber 150. Engine block 104 further defines an intake port 108, wherein intake assembly is fluidically coupled to chamber 150 via intake port 108. Engine block 104 further defines and exhaust port 110, wherein exhaust assembly is fluidically coupled to chamber 150 via exhaust port 110. In some embodiment, exhaust port 110 may be selectively fluidically coupled to the exhaust assembly via an exhaust valve (not shown), which can selectively seal cylinder 106 for combustion when closed or selectively allow exhaust to escape cylinder 106 when open. However, exhaust valve in some embodiments may be integral with a piston which covers and uncovers exhaust port 110 throughout the engine cycle. In some embodiments, powertrain assembly 100 includes a transfer port 112. In some embodiments, transfer port 112 is defined within engine block 104. Powertrain assembly 100 includes at least one spark plug 114 positioned proximate or at least partially within the chamber 150. For example, powertrain assembly 100 may include a cylinder head cover 116. Cylinder head cover 116 may be coupled to engine block 104 or integral with engine block 104 to define a portion of the boundary of chamber 150. Spark plug 114 can be positioned with cylinder head cover 116.

Intake assembly 200 includes fuel system 210 which further includes fuel lines 212 and fuel injector 214. Fuel lines 212 provide fuel to the fuel injector 214 which inject fuel for combustion in chamber 150. Intake manifold 202 is coupled to the engine block 104 and is in fluidic communication with throttle body. Air for the combustion processes is admitted into chamber 150 through throttle body, intake manifold 202, and intake port 108. Throttle body which may be controlled directly through the use of an accelerator pedal or hand-operated input. As air and fuel are introduced to chamber 150, the fuel is at least partially atomized in the air to prepare for combustion.

Powertrain assembly 100 further includes a piston 120. Piston 120 is positioned at least partially in cylinder 106 and is moveable within cylinder 106. In some embodiments, chamber 150 includes various portions, for example a first portion 152 and a second portion 154. First and second portions 152, 154 are representative only and are not intended to be strictly understood as separate or distinct chambers but are provided for the purpose of understanding the systems discussed herein. For example, in some embodiments, the first portion 152 includes a combustion chamber and the second portion 154 includes a crankcase chamber. The first and second portions 152, 154 may be part of the same chamber (e.g., chamber 150). In some embodiments, first and second portion 152, 154 are separated or delineated by piston 120. Transfer port 112 fluidically coupled first portion 152 and second portion 154.

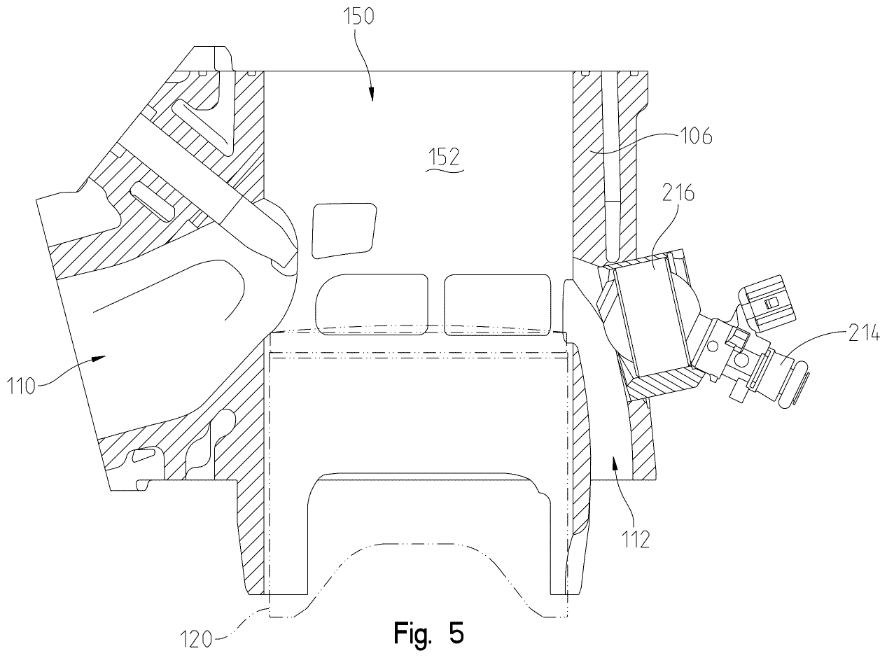

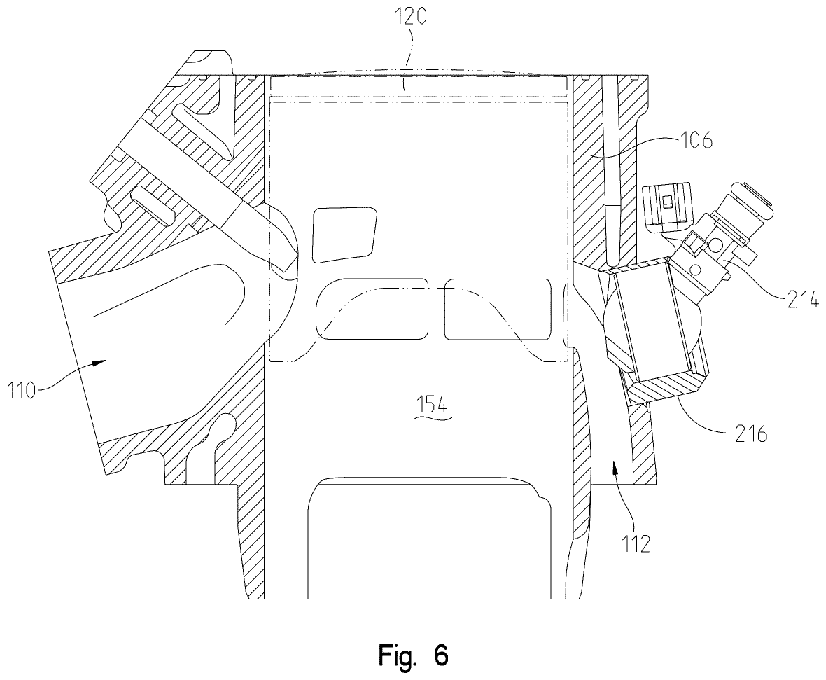

Referring to FIG. 5, fuel injector 214 is positioned to provide fuel into chamber 150. Fuel injector 214 is moveable between a first position and a second position. In some embodiments, fuel injector 214 is positionable in a plurality of various positions. The various positions facilitate various combustion profiles. The various positions and combustion profiles are discussed hereafter in more detail. In one embodiment, when fuel injector 214 is positioned in the first position, fuel injector 214 supplies fuel to the first portion 152 of chamber 150. This may be implemented to facilitate starting of a vehicle in cold ambient temperatures. By supplying fuel directly into first portion 152 (e.g., the combustion chamber), the average number of cycles of engine 102 during starting is decreased. This facilitates more efficient and faster engine starts, especially at low temperatures. Additionally, engine 102 may run with more power and more efficiently under certain parameters (e.g., low RPMs, throttle positions, water temperature, engine temperature, exhaust temperature, and barometric pressure). Once the engine has exceeded at least one of those parameters, fuel injector 214 may be repositioned in the second position (see FIG. 6) to supply fuel to second portion 154 of chamber 150. The switching between the first and second positions may be triggered by a single condition or a combination of conditions. The determination to switch between the first and second positions may be optimized for various factors including performance, efficiency, exhaust, and so forth.

Referring more specifically to the first and second positions, in some embodiments, fuel injector 214 is angularly adjustable relative to the engine block 104. This may be accomplished by coupling fuel injector 214 to engine block 104 via a pivoting coupling member 216. In some embodiments, pivoting coupling member includes a ball joint or other type of joint facilitating movement between various positions (e.g., a pin joint). For example, FIG. 5 illustrates fuel injector 214 positioned in the first position and FIG. 6 illustrates fuel injector 214 rotated from the first position to the second position. The angle across which fuel injector 214 may be rotated may be anywhere from about 5 degrees to about 175 degrees. For example, the range of motion of fuel injector 214 may be from about 5 degrees to about 15 degrees, from about 15 degrees to about 25 degrees, from about 25 degrees to about 35 degrees, from about 35 degrees to about 45 degrees, from about 45 degrees to about 55 degrees, from about 55 degrees to about 65 degrees, from about 65 degrees to about 75 degrees, from about 75 degrees to about 85 degrees, from about 85 degrees to about 95 degrees, from about 95 degrees to about 105 degrees, from about 105 degrees to about 115 degrees, from about 115 degrees to about 125 degrees, from about 125 degrees to about 135 degrees, from about 135 degrees to about 145 degrees, from about 145 degrees to about 155 degrees, from about 155 degrees to about 165 degree, and from about 165 degrees to about 175 degrees. Any intermediate range or combination of ranges is contemplated herein. In some embodiments, fuel injector 214 may be positioned at first and second positions such that the first and second positions are separated by any of the recited degrees or ranges of degrees. Additionally, any number of intermediate positions may be implemented.

In some embodiments, powertrain assembly 100 further includes an actuator 218 coupled to fuel injector 214. Actuator 218 is operable to move fuel injector 214 between the first position and the second position. Actuator 218 may be operable to move fuel injector 214 between various predetermined positions or may be able to move fuel injector 214 between infinitely variable positions. Actuator 218 may operate via various mechanisms including motors, hydraulics, and so forth. Actuator 218 may be configured to operate based on instructions from a controller 220. Controller 220 is operable to provide instructions to actuator 218 to cause actuator 218 to transition fuel injector 214 between various positions (e.g., the first position and the second position) based on predetermined conditions. In some embodiments, non-limiting examples of predetermined conditions include, either alone or in combination, speed, power status, RPM, ambient temperature, engine temperature, throttle position, and so forth. In some embodiments, fuel injector 214 may be positioned in the first position or the second position based on the status of exhaust port 110 (e.g., opened or closed). For example, fuel injector 214 may be positioned in the first position when exhaust port 110 is open and may be in the second position when exhaust port 110 is closed.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A vehicle comprising:
a plurality of ground engaging members;
a frame supported by the plurality of ground engaging members; and
a powertrain assembly supported by the frame and operably coupled to at least one of the plurality of ground engaging members, wherein the powertrain assembly includes an engine block defining a cylinder and a fuel injector positioned to provide fuel into the cylinder, wherein the fuel injector is moveable between a first position and a second position.

2. The vehicle of claim 1, wherein the cylinder defines a chamber including a first portion and a second portion, wherein the fuel injector is operable to provide fuel to the first portion of the chamber when in the first position and is operable to provide fuel to the second portion of the chamber when in the second position.

3. The vehicle of claim 1, wherein the fuel injector is angularly adjustable relative to the engine block.

4. The vehicle of claim 3, wherein the fuel injector is angularly adjustable from about 50 degrees to about 90 degrees between the first position and the second position.

5. The vehicle of claim 1, wherein the fuel injector is coupled to the engine block via a pivoting coupling member.

6. The vehicle of claim 5, wherein the pivoting coupling member includes a ball joint.

7. The vehicle of claim 1, wherein the powertrain assembly further includes an actuator coupled to the fuel injector, wherein the actuator is operable to move the fuel injector between the first position and the second position.

8. The vehicle of claim 7, wherein the powertrain assembly further includes a controller, wherein the controller is operable to cause the actuator to transition the fuel injector between the first position and the second position based on a predetermined condition.

9. The vehicle of claim 8, wherein the predetermined condition includes at least one of speed, power status, RPM, ambient temperature, engine temp, and throttle position.

10. The vehicle of claim 1, wherein the powertrain assembly further includes an exhaust valve, wherein the fuel injector is positioned in the first position or the second position based on a position of the exhaust valve.

11. A powertrain system comprising:
an engine block defining a cylinder;
a piston positioned at least partially within the cylinder; and
a fuel injector positioned to provide fuel into the cylinder, wherein the fuel injector is moveable between a first position and a second position.

12. The powertrain system of claim 11, wherein the cylinder defines a chamber including a first portion and a second portion, wherein the fuel injector is operable to provide fuel to the first portion of the chamber when in the first position and is operable to provide fuel to the second portion of the chamber when in the second position.

13. The powertrain system of claim 11, wherein the fuel injector is angularly adjustable relative to the engine block.

14. The powertrain system of claim 11, further comprising a pivoting coupling member, wherein the fuel injector is coupled to the engine block via the pivoting coupling member.

15. The powertrain system of claim 14, further comprising an actuator coupled to the fuel injector, wherein the actuator is operable to move the fuel injector between the first position and the second position.

16. The powertrain system of claim 15, further comprising a controller, wherein the controller is operable to cause the actuator to transition the fuel injector between the first position and the second position based on a predetermined condition.

17. A fuel injection system for coupling to a powertrain assembly, the fuel injection system comprising:
a fuel injector positioned to provide fuel into a cylinder of the powertrain assembly; and
a coupling member operable to moveably couple the fuel injector to the powertrain assembly, wherein the coupling member is operable to allow the fuel injector to move between a first position and a second position.

18. The fuel injection system of claim 17, wherein the coupling member includes a ball joint.

19. The fuel injection system of claim 17, further comprising an actuator coupled to the fuel injector, wherein the actuator is operable to move the fuel injector between the first position and the second position.

20. The fuel injection system of claim 19, further comprising a controller, wherein the controller is operable to cause the actuator to transition the fuel injector between the first position and the second position based on a predetermined condition.
